(19) United States
(12) Patent Application Publication
(10) Pub. No.: US 2009/0133456 A1
(43) Pub. Date: May 28, 2009

(54) PROCESS AND MECHANISM TO PRODUCE GRANULATED ORGANIC-MINERAL FERTILIZER BASED ON CONCENTRATED VINASSE

(75) Inventors: Luis Galo ZAPATA RIVERA, Plazas Verdes (CO); Gabriel Aurelio ZARATE, Plazas Verdes (CO); Jose Vicente ZAPATA R., Yumbo (CO)

Correspondence Address: ALBERT BORDAS, P.A., 5975 SUNSET DRIVE, SUITE 607, MIAMI, FL, 33143, US

(73) Assignee: Kimel of Colombia S.A., Palmira (CO)

(21) Appl. No.: 12/276,093

(22) Filed: Nov. 21, 2008

(30) Foreign Application Priority Data
Nov. 23, 2007 (CO) 07-124320

(51) Int. Cl. C05F 11/00

(52) U.S. Cl. 71/23

(57) ABSTRACT

A process and mechanism to produce granulated organic-mineral fertilizer based on concentrated vinasse, comprising specific conditions of raw material preparation, volume and amounts of mixtures, humidity of the materials used in the mixture, homogenization, granulation, drying and packaging, relation on amount of the product intended to granulate versus length of the granulator cylinder, temperature of the gases for draying, speed of the gas for draying and relation on the length versus diameter of the dryer. To improve the fertilizer composition and its mixing with conventional fertilizers, the present invention uses other sub-products from the sugar cane mill and alcohol distillery industries to obtain organic-mineral fertilizers that replace conventional fertilizers, providing organic materials and microorganisms, required for the reactivation of the soil fertility and a superior approach by the plants, resulting in an increasing of the harvesting productivity and the use of smaller amounts compared with conventional fertilizers.

### BACKGROUND OF THE INVENTION

1. Field of the Invention

The present invention relates to a process and mechanism to produce granulated organic-mineral fertilizer based on concentrated vinasse, and more particularly, to a process and mechanism to produce granulated organic-mineral fertilizer based on concentrated vinasse for use in the agriculture, as water-soluble granules obtained from residuals of food and ethylic alcohol productions, such as alcohol distillers known as concentrated vinasse. The process of concentrated vinasse and sugar cane mills residuals and alcohol is developed in five basic steps: mixing, homogenization, pulverizing, granulation, drying and packing. The product obtained of this process is used as organic-mineral fertilizer. The invention uses known engineering unitary processes with improvements to structural parts and conditions of operations.

The process comprises specific conditions of raw material preparation, volume and amounts of mixtures, humidity of the materials used in the mixture, homogenization, granulation, drying and packaging, relation on amount of the product intended to granulate versus length of the granulator cylinder, temperature of the gases for draying, speed of the gas for draying and relation on the length versus diameter of the dryer.

To improve the fertilizer composition and its mixing with conventional fertilizers, the present invention uses other sub-products from the sugar cane mill and alcohol distillery industries to obtain organic-mineral fertilizers that replace conventional fertilizers, providing organic materials and microorganisms, required for the reactivation of the soil fertility and a superior approach by the plants, resulting in an increasing of the harvesting productivity and the use of smaller amounts compared with conventional fertilizers.

2. Other Related Applications

The present application claims priority under Paris Convention of pending Peruvian Patent Application No. 07-124320, filed on Nov. 23, 2007, which is hereby incorporated by reference.

3. Description of the Related Art

Concentrated vinesse is an organic residual of the distillation of alcoholic liquors from the fermentation of sugar cane molasses with yeast from which the alcohol is extracted by means of distillation. Concentrated vinesse has important qualities as organic fertilizer, potassium, calcium sulfate and magnesium provider, and micronutrients such as iron, manganese, zinc and copper, chelate organic material. For its high containing of complex B vitamins and amino acids from yeast autolysis, it is also used as row material for the production of microorganisms good for the soil and as complement in the formulations for animal nutrition.

A typical analysis of different sources indicates that concentrated vinasse at 50 Brix degrees, is high in total organic material (44%), has 8% sugars, 5% proteins, 14% ashes, 5% potassium as K₂O, 3% calcium as CaO, 2% magnesium as MgO, and chelated micro nutrients in the organic material with iron, manganese, zinc and copper.

Concentrated vinasse organic material is normally chelated, especially as molecules of different alcohols (4.3%), carboxylic acids (5.6%) and fulvic acids (35%), which have the characteristic to form very stable chelates. The organic acids found are, basically, acetic, lactic, aconitic, matic and citric acids. The fulvic acids found in the vinasse have a molecular average weight of 4500 gl/mol, which is foliarly assimilable, and for which its capacity of generate coordinated bonds with bivalent and trivalent cations to generate complex chelates of iron, copper, manganese, zinc and boron.

Concentrated vinasse characteristics are, basically, high hygroscopicity, which accelerate the humidification and agglomeration of particles, high presence of chelated organic compounds, specifically molecules of carboxylic acids and fulvics acids characterized by produce more stable chelated.

The same characteristics and composition of the chelated compounds, added to a corrosive acid characteristic for metals, make concentrated vinasse very difficult to manage, requiring the use of special procedures for its handling, mixture with other ingredients and its posterior drying, because impermeable layers are formed that caramelize and jellify.

On the other hand, the known forms of concentrated vinasse use, with a concentration up to 60° Brix, is high in water, which does not allow a correct granulation of the product, because non homogeneous agglomerated mass that partially splits during drying, forming a mixture of large grumous and the remaining pulverized material that cannot be used and reduce the probability to reach the organic carbon required to consider the final product as organic.

Organic material granulation with vinasse cannot be suitably made in large granulates, such as the ones with disk and cup shapes, because the granulation effective length is too short to form granulates of the required size. If the time or the amount of binder the results would be large spherical masses that cannot be dry and handled with the use of conventional fertilizer machines.

In the same way, the drying organic fertilizer containing vinasse in conventional rotation dryers is not suitable because the speed and temperature of the drying gases is higher than the organic materials permit, causing degradation of the organic component, expelling of particles to the atmosphere with consequent contamination, and destruction of beneficial microorganisms. Also, it has been demonstrated that humidity contents lower than 24% at the entrance of the granulator, cause degradation of the particles during drying provided by the lack of binding for the vinasse. This way, humidity contents higher than 27% at the entrance of the granulator, cause the formation of granules larger than 4 mm, which do not dry completely resulting in a final product with humidity higher than 5%.

Finally, during the packing and storing process of the bags of fertilizer based on concentrated vinasse, if the product humidity is higher than 10%, the product bonds.

From the sugar cane process to produce sugar, sub products and residuals are obtained, such as cake mud. In sugar mills, cake mud is transformed in piles of 1.5 m high and 100 m length, using mixtures of vinasse of average concentration (20°-25° Brix) and sugarcane bagasse or residuals of the sugarcane harvesting, for 45 to 90 days periods, with continue supplying of air using mechanical equipments to turn them around. This way, a compound is obtained having excellent biotic properties and containing organic nitrogen, potassium, slow liberation phosphorus, and being mixable with other organic fertilizer, such as concentrated vinasse and conventional fertilizer.

The difficulty of the use of the compound cake mud-vinasse is in the tendency to form grumous larger than 5 cm diameter, which are hard and impermeable after drying. It makes difficult its mixing with other components. Additionally, this compound contains big portions of bagasse that cannot decompose during the process and difficult their use for granulation.

The sugarcane bagasse, paper factories residual bagasse, rise rind and their dashes can provide high amounts of amorphous silica, necessary to reduce the stress of the plants, organic material and nutrients. However, because of their high humidity and length of the fiber they the difficult the formation of granules smaller than 4 mm.

Yeast organic mud and other fermentation residuals obtained from alcochemistry and sucrochemistry industries, contain considerable amounts of organic material, protein, complex B vitamins, which are very important for the plants development. However, the use in fertilizer production is difficult because the usual drying temperatures, normally higher than 180° C., destroy its nutritional value.

At the moment, there are generic processes that permit the partial or total use of the above-mentioned residuals to produce pulverized organic fertilizers or soil correctors without a specific granulometria.

The state of the art in the production of organic fertilizer based on vinasse in mixture with other materials, are limited procedures and do not have operation conditions that permit a suitable handling of the materials with high productivity and efficiency to compete in cost-benefit in the market. The high production volume of vinasse from distillers requires more creativity to bring suitable solutions to handling of vinasse. Otherwise, it would represent an ambient contaminant when its disposition is not suitable. Also, there are other processes to obtain granulated fertilizers using concentrated vinasse as partial binder. Those processes are difficult because the hygroscopic characteristic of the vinasse and its thixotropic properties that difficult the mixing, homogenization, granulating and drying, without reach an uniform granulated, between 2 and 4 mm diameter of the grain, with interior humidity lower than 5%, without lose its nutritional properties and its beneficial microorganisms from the compost. There are no antecedents either of production of mineral organic fertilizer soluble grains that are homogeneous in composition.

In view of the above-mentioned, the present invention has found a specific methodology with specially designed equipments for this purpose, that permit the production of granulated organic fertilizers and mineral organic fertilizers, with the required proportion and quality for the use of amounts of concentrated vinasse and its suitable presentation for commercialization with competitive conditions of cost-benefit.

### SUMMARY OF THE INVENTION

It is one of the main objects of the present invention to provide a process and mechanism to produce granulated organic-mineral fertilizer based on concentrated vinasse that comprises equipment specially prepared to provide organic-mineral fertilizers as water-soluble granules of concentrated vinasse.

It is another object of this invention to provide a process and mechanism to produce granulated organic-mineral fertilizer based on concentrated vinasse that provides organic and/or organic-mineral products with a granulometry between 2 and 4 mm, water soluble, with a maximum humidity of 5% and high content of microorganisms for the soil beneficial.

It is yet another object of this invention to provide such an invention that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1A represents a schematic side view of the equipments of the fertilizer granulator of present invention. It comprises feeding chamber (1), elevator (2), blade mixer (3), horizontal blade homogenizator (4), crumblier (5), rotary cylindrical granulator (6), humid grains conveyor (7), rotary dryer (8), humid gases extractor (9), dry grains conveyor (10), rotating grains cooler (11), cold gases extractor (12), size selection vibrating sieve (13) and packing scale (14).

FIG. 1B is a schematic top view of the invention shown in FIG. 1A.

FIG. 2A is a top schematic view showing the details of the blade mixer (3) having a mechanic arm (15) for the product uploading by pneumatic actuating once he mixing has been completed.

FIG. 2B is a side schematic view of the blade mixer (3) shown in FIG. 2A.

FIG. 3A is a side schematic view showing the details of the horizontal blade homogenizator (4) having an electronic speed controller (16) and a product regulator notch (17), which change the load-by-load process into a continuous process, by delivering doses of the homogenized humid product in a permanent way.

FIG. 3B is a top schematic view of the horizontal blade homogenizator (4) shown in FIG. 3A.

FIG. 4A is a schematic top view showing the details of the of the crumblier (5) being a hammer mill with hammers (18) design, which work at 1200 rpm, comprising 240 hammers by tons of dry product.

FIG. 4B is a schematic side view of the crumblier (5) shown in FIG. 4A.

FIG. 5A is a schematic front view showing the details of the rotary cylindrical granulator (6) comprising a scraper blade (19) of a minimal length of 1.5 m/ton of treated product, and an electronic regulator of the rotary speed (20).

FIG. 5B is a schematic side view of the rotary cylindrical granulator (6) shown in FIG. 5A.

### DETAILED DESCRIPTION OF THE PREFERRED EMBODIMENT

The present invention offers a specific procedure, with equipment and conditions of operation specially modified to obtain granulated organic-mineral fertilizer based on concentrated vinasse, as spherical grains of a size of 2-4 mm and with less than 5% humidity.

The preferred embodiment for the present invention comprises the steps of:

Preparation of the raw material. To mix, granulate and drying organic materials containing vinasse, special conditions are required.

Concentrated vinasse, normally commercialized at 55° Brix, is concentrated by direct evaporation or mixing with powder vinasse to 67°-70° Brix to get a maximum humidity of 44%, which is necessary to obtain a suitable granulation of the final product, as well as 2-4 mm grains of spherical shape and a humidity of the dry product of 5%.

Additionally, the vinasse is enriched in proteins and probiotic minimum content of 10%, by adding residual yeast cream from distillers and previously concentrated up to 35% of solids.

Cake mud compound is conditioned with a 10% minimum of bagasse ashes and/or rice rind ashes, to provide the required porosity and absorbency to the product, which provide a suitable humidity when combined with concentrated vinasse during the granulating process.

Cake mud compound and the other required products required for a fertilizer with a suitable composition, are previously dried and powdered using hammer mills to obtain a humidity less than 5% and a particle size smaller than 4 mm.

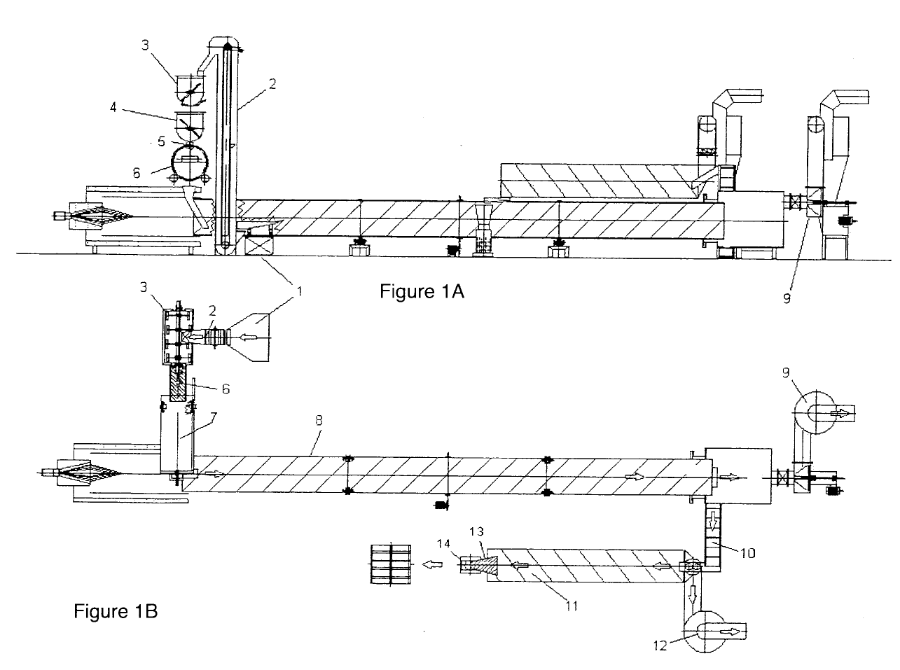

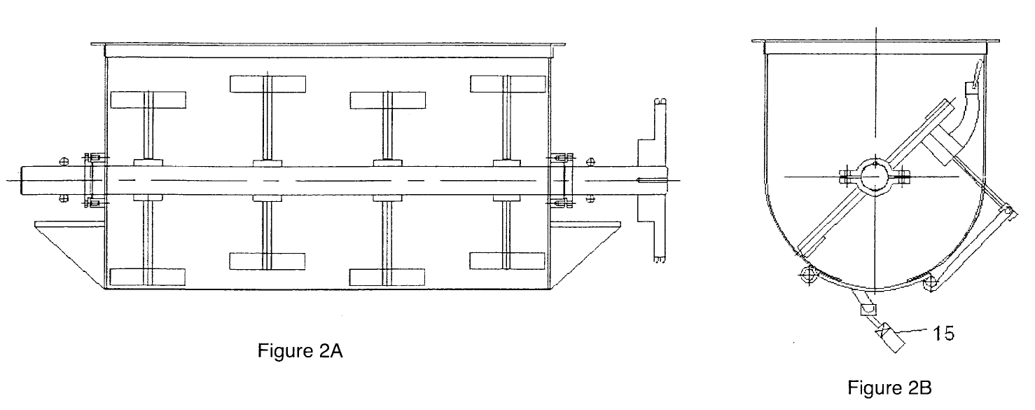

Mixing. The mixing is made by the feeding of the solid products from feeding chamber 1, with elevator 2, as best seen in FIGS. 1A and 1B. Then concentrated liquid vinasse is added to blade mixer 3. Blade mixer 3 has been modified for this purpose with mechanic arm 15 having a pneumatic driving system, as best seen in FIGS. 2A and 2B, which secure the complete evacuation of the homogenized product avoiding the residual accumulation and securing the complete mixing of the products without any alteration of the formulation. Concentrated vinasse of 68° Brix is mixed with the components previously selected in a proportion of 50% by mass to have a final product with 20% organic carbon. The resulting mixture has a humidity of 24% and 27%, required to form and dry the grains. During the mixing, conventional fertilizer components are added to obtain a final granulated with the wished composition. Such conventional fertilizer components are from the group of, but are not limited to, phosphoric rock, ammonia phosphates, urea, nitric acid, sulfuric acid, potassium chloride, phosphoric acid, or ammonia nitrate.

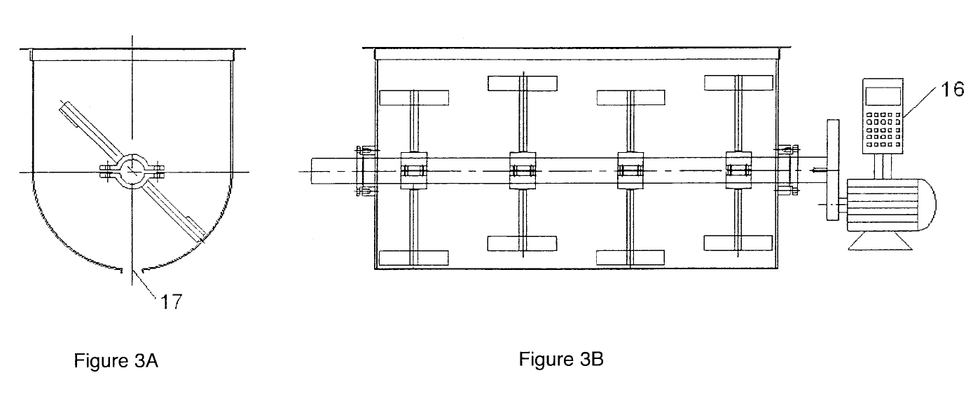

Homogenization and doses. Homogenization is made through horizontal blade homogenizator 4 (shown in FIGS. 1A, 1B, 3A, and 3B) comprising a central axle with arms having blades, and further comprising electronic shaking speed controller 16, which regulate the time according to each humid mixture. Product regulator notch 17, disposed at the bottom of horizontal blade homogenizator 4, allows the continuous delivery of doses into crumblier 5. This way, the process changes from a load-by-load process into a continuous process. Product regulator notch 17 is designed according to the velocity of the axle of horizontal blade homogenizator 4 and to the feeding volume by time unit.

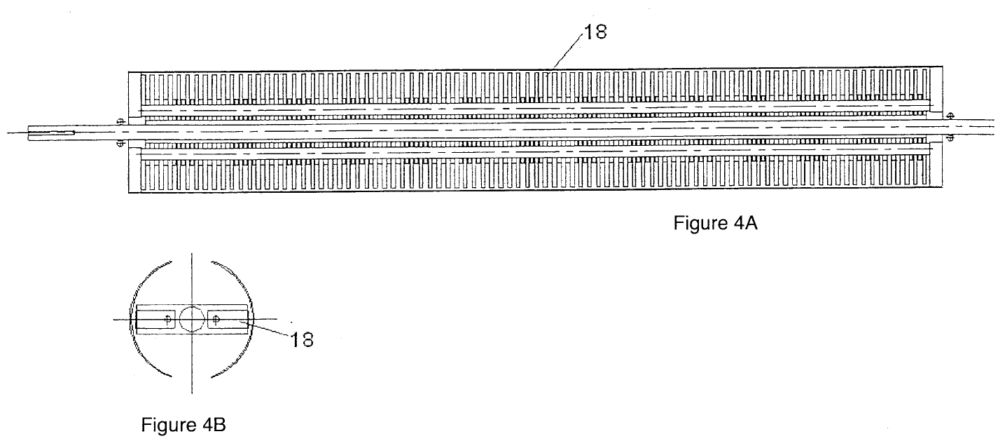

Crumbling. The crumbling is made with crumblier 5, which is a radial hammer mill (seen in FIGS. 1A, 1B, 4A, 4B). Crumblier 5 basically comprises 240 hammers (18) without a size separator sift. Crumblier 5 is installed under horizontal blade homogenizator 4 and it permits the pulverization of the vinasse humid material with organic material, and delivering them to a conventional conveyor for posterior granulation.

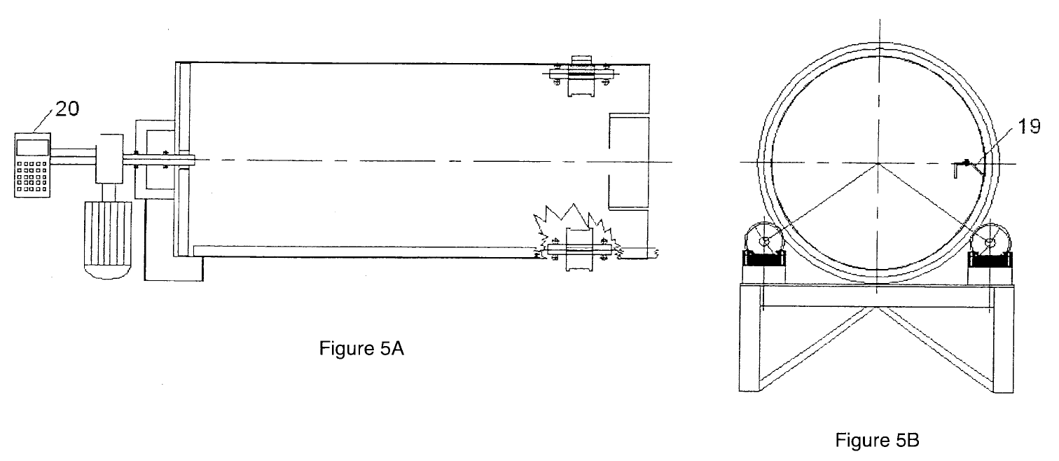

Granulation. The process is made with a conventional rotary cylindrical granulator 6, as seen in FIGS. 1A, 1B, 5A, 5B. Rotary cylindrical granulator 6 preferably comprises electronic regulator of the rotary speed 20 and a granulation arm or scraper blade 19 of 1.5 m minimum effective length. With this disposition, grains of 2-4 mm diameter are obtained.

Drying. Drying is made with parallel flow rotary dryer 8, as seen in FIGS. 1A and 1B. Rotary dryer 8 is designed, preferably, to dry organic products, when the relation length (L) to section diameter (D) is changed to L/D=14.5. As preferred operation condition the drying gases temperature is kept at 900° C., in such a way that particles are dried at a maxim temperature of 110° C. This way a controlled drying of the grains is ensured, without substantially deteriorate the benefic microorganisms and securing a humidity of the final product lower than 5%.

Cooling and packaging. Cooling is made with rotating grains cooler 11, size selection vibrating sieve 13 to separate grains larger than 7 mm, and conventional packing scale 14. The product cooling is made at 27° C. with a maxim humidity of 5% to secure the final product does not stick together when it is stored in bags.

Therefore, the present invention is a process and mechanism to produce granulated organic-mineral fertilizer based on concentrated vinasse, comprising the following steps:

A) preparing a raw material by evaporation of vinasse to produce a concentrated vinasse, said evaporation occurs at approximately 70° Brix, said concentrated vinasse is enriched with approximately 10% yeast cream and a cake mud compound is added with a minimum of 10% bagasse ashes and/or rice rind ashes, said raw material is dried to obtain a humidity of approximately 5%, said raw material is approximately 2-4 mm in particle size;

B) mixing said raw material with concentrated liquid vinasse at approximately 70° Brix and conventional fertilizer components selected from a group consisting of phosphoric rock, ammonia phosphates, urea, nitric acid, sulfuric acid, potassium chloride, phosphoric acid, or ammonia nitrate to produce a first compound;

C) homogenizing said first compound to allow a continuous delivery of doses as a second compound into a crumblier;

D) crumbling said second compound to produce a pulverized humid material;

E) granulizing said pulverized humid material to obtain to granulated organic-mineral fertilizer of approximately 2-4 mm diameter is size;

F) drying said granulated organic-mineral fertilizer with drying gas temperatures at a dryer entrance of approximately 900° C. and at a maximum temperature of approximately 110° C.; and

G) cooling said granulated organic-mineral fertilizer at a maximum temperature of approximately 27° C.

The granulated organic-mineral fertilizer is a soluble grain, and is approximately between 2-4 mm in size. Furthermore, the granulated organic-mineral fertilizer comprises a maximum humidity of 5%.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A process and mechanism to produce granulated organic-mineral fertilizer based on concentrated vinasse, comprising the following steps:
A) Preparation of raw material: Concentrated vinasse is concentrated by evaporation 70° Brix and enriched with 10% of yeast cream residuals from distillers, cake mud compound is added with a 10% minimum of bagasse ashes, rice rind ashes, or both, other required organic and inorganic components required for a suitable fertilizer composition are dried to obtain a humidity of 5% and a 2-4 mm particle size;
B) Mixing: The mixing is made by the feeding of the solid products from a feeding chamber (1), with an elevator (2), and adding concentrated liquid vinasse at 70° Brix to a blade mixer (3), during the said mixing other conventional fertilizer components are added, said conventional fertilizer components are from the group of, but are not limited to, phosphoric rock, ammonia phosphates, urea, nitric acid, sulfuric acid, potassium chloride, phosphoric acid, or ammonia nitrate;
C) Homogenization and doses: Homogenization is made through a horizontal blade homogenizator (4) comprising an electronic shaking speed controller (16), and a product regulator notch (17) disposed at the bottom of said horizontal blade homogenizator (4) to allow the continuous delivery of doses into a crumblier (5);
D) Crumbling: The crumbling is made with said crumblier (5), which is a radial hammer mill without a size separator sift, and installed under said horizontal blade homogenizator (4) that delivers pulverized humid material a conventional conveyor;
E) Granulation: It is made with a conventional rotary cylindrical granulator (6), comprising a speed regulator to obtain grains of 2-4 mm diameter of diameter;
F) Drying: It is made with a parallel flow rotary dryer (8) designed with a relation of length (L) to section diameter (D) of 14.5 (L/D=14.5), with drying gases temperature at the entrance of dryer of 900° C. for drying of particles at a maxim temperature of 110° C.; and
G) Cooling and packaging: Cooling is made at a rotating grains cooler (11) with a size selection vibrating sieve (13) at a maxim temperature of 27° C. with a maxim humidity of 5%.

2. The process and mechanism to produce granulated organic-mineral fertilizer based on concentrated vinasse set forth in claim 1, further characterized in that the final product is as soluble grains, with a size of 2-4 mm and maxim humidity of 5%.

3. A process and mechanism to produce granulated organic-mineral fertilizer based on concentrated vinasse, comprising the following steps:
A) preparing a raw material by evaporation of vinasse to produce a concentrated vinasse, said concentrated vinasse is enriched with yeast cream and a cake mud compound is added with bagasse ashes and/or rice rind ashes, said raw material is dried;
B) mixing said raw material with concentrated liquid vinasse and conventional fertilizer components selected from a group consisting of phosphoric rock, ammonia phosphates, urea, nitric acid, sulfuric acid, potassium chloride, phosphoric acid, or ammonia nitrate to produce a first compound;
C) homogenizing said first compound to allow a continuous delivery of doses as a second compound into a crumblier;
D) crumbling said second compound to produce a pulverized humid material;
E) granulizing said pulverized humid material to obtain to granulated organic-mineral fertilizer;
F) drying said granulated organic-mineral fertilizer; and
G) cooling said granulated organic-mineral fertilizer.

4. The process and mechanism to produce granulated organic-mineral fertilizer based on concentrated vinasse set forth in claim 3, further characterized in that said granulated organic-mineral fertilizer is a soluble grain.

5. The process and mechanism to produce granulated organic-mineral fertilizer based on concentrated vinasse set forth in claim 3, further characterized in that said granulated organic-mineral fertilizer is approximately between 2-4 mm in size.

6. The process and mechanism to produce granulated organic-mineral fertilizer based on concentrated vinasse set forth in claim 3, further characterized in that said granulated organic-mineral fertilizer comprises a maximum humidity of 5%.

7. A process and mechanism to produce granulated organic-mineral fertilizer based on concentrated vinasse, comprising the following steps:
A) preparing a raw material by evaporation of vinasse to produce a concentrated vinasse, said evaporation occurs at approximately 70° Brix, said concentrated vinasse is enriched with approximately 10% yeast cream and a cake mud compound is added with a minimum of 10% bagasse ashes and/or rice rind ashes, said raw material is dried to obtain a humidity of approximately 5%, said raw material is approximately 2-4 mm in particle size;
B) mixing said raw material with concentrated liquid vinasse at approximately 70° Brix and conventional fertilizer components selected from a group consisting of phosphoric rock, ammonia phosphates, urea, nitric acid, sulfuric acid, potassium chloride, phosphoric acid, or ammonia nitrate to produce a first compound;
C) homogenizing said first compound to allow a continuous delivery of doses as a second compound into a crumblier;
D) crumbling said second compound to produce a pulverized humid material;
E) granulizing said pulverized humid material to obtain to granulated organic-mineral fertilizer of approximately 2-4 mm diameter is size;
F) drying said granulated organic-mineral fertilizer with drying gas temperatures at a dryer entrance of approximately 900° C. and at a maximum temperature of approximately 110° C.; and
G) cooling said granulated organic-mineral fertilizer at a maximum temperature of approximately 27° C.

8. The process and mechanism to produce granulated organic-mineral fertilizer based on concentrated vinasse set forth in claim 7, further characterized in that said granulated organic-mineral fertilizer is a soluble grain.

9. The process and mechanism to produce granulated organic-mineral fertilizer based on concentrated vinasse set forth in claim 7, further characterized in that said granulated organic-mineral fertilizer is approximately between 2-4 mm in size.

10. The process and mechanism to produce granulated organic-mineral fertilizer based on concentrated vinasse set forth in claim 7, further characterized in that said granulated organic-mineral fertilizer comprises a maximum humidity of 5%.
